(19) United States
(12) Patent Application Publication
(10) Pub. No.: US 2017/0310451 A1
(43) Pub. Date: Oct. 26, 2017

(54) FULL-DUPLEX REAL-TIME CROSS-MODULE UPDATES OF CUSTOMER RELATIONSHIP MANAGEMENT (CRM) DATA IN A CRM DATA PROCESSING SYSTEM

(71) Applicant: SugarCRM Inc., Cupertino, CA (US)

(72) Inventor: John Barlow, Drive Fishers, IN (US)

(21) Appl. No.: 15/136,891

(22) Filed: Apr. 23, 2016

(51) Int. Cl. H04L 5/14; H04L 29/06

(52) U.S. Cl. CPC H04L 5/14; H04L 65/1073

(57) ABSTRACT

Embodiments of the invention provide a method, system and computer program product for full-duplex real-time cross-module updates of customer relationship management (CRM) data. The method includes registering a first CRM module of a multi-user CRM data processing system for full-duplex data integration with a second CRM module. Thereafter, a full-duplex communications channel between the first and second CRM modules is established. Finally, in response to a data change in the second CRM module, the data change is pushed utilizing the full-duplex communications channel to the first CRM module, and data in the first CRM module is changed based upon the pushed data change.

### BACKGROUND OF THE INVENTION

### Field of the Invention

The present invention relates to CRM and more particularly to data synchronization in a CRM data processing system.

### Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

CRM systems are often used to manage the entire lifecycle of a relationship between a customer and an organization. In this regard, a CRM system is enabled to manage tasks for organizational representatives associated with the targeting and acquisition of a new customer, the fulfillment of a sale to a new customer or an existing customer, and the maintenance of a relationship with an existing customer. Much of the role of the CRM system is to store data documenting the relationship between representatives of an organization and its customers and prospective customers. Thus, the typical CRM system takes a long view of the customer relationship from inception to conclusion which may last many years or even decades.

CRM systems generally are multi-user such that multiple different end users in an organization access, add, remove and modify CRM data objects including customer data, opportunity data and sales cycle data. CRM data objects within the CRM system, though, are highly relatable such that a change in one data object applied by one end user in one module of the CRM system can have an important effect upon the use of the same or different data objects accessed by other end users in the same or different modules of the CRM system. The typical CRM system, however, does not operate on a real-time basis so that when one end user views a report of CRM information or even merely a screen of CRM information, the CRM information reflected in the screen or report may not be current and thus not accurate.

### BRIEF SUMMARY OF THE INVENTION

Embodiments of the present invention address deficiencies of the art in respect to CRM data synchronization and provide a novel and non-obvious method, system and computer program product for full-duplex real-time cross-module updates of CRM data. In an embodiment of the invention, a method for full-duplex real-time cross-module updates of CRM data in a CRM data processing system includes registering a first CRM module of a multi-user CRM data processing system for full-duplex data integration with a second CRM module. Thereafter, a full-duplex communications channel between the first and second CRM modules is established, for example a full-duplex communications channel implemented utilizing the WebSockets protocol. Finally, in response to a data change in the second CRM module, the data change is pushed utilizing the full-duplex communications channel to the first CRM module, and data in the first CRM module is changed based upon the pushed data change.

In one aspect of the embodiment, the first CRM module of the multi-user CRM data processing system is a different type of CRM module than the second CRM module of the multi-user CRM data processing system. In another aspect of the embodiment, a notification is displayed in a user interface of each end user of the CRM data processing system accessing the first CRM module alerting each end user to the pushed data change. In yet another aspect of the embodiment, a multiplicity of end users of the CRM data processing system access the first CRM module in respectively different user interfaces to the first CRM module and are presented with the data change in each of the different user interfaces.

In another embodiment of the invention, a CRM data processing system is configured for full-duplex real-time cross-module updates of CRM data. The system includes a host computing platform including one or more computers, each with memory and at least one processor. The system also includes a multi-user CRM data processing system executing in the memory of the host computing platform. Finally, the system includes a full-duplex CRM data integration module coupled to the multi-user CRM data processing system. The full-duplex CRM data integration module includes program code that when executing in the memory of the host computing platform is enabled to register a first CRM module of the multi-user CRM data processing system for full-duplex data integration with a second CRM module, to establish a full-duplex communications channel between the first and second CRM modules, and to respond to a data change in the second CRM module by pushing the data change utilizing the full-duplex communications channel to the first CRM module and changing data in the first CRM module based upon the pushed data change.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for full-duplex real-time cross-module updates of CRM data in a CRM data processing system;

FIG. 2 is a schematic illustration of a CRM data processing system configured for full-duplex real-time cross-module updates of CRM data; and,

FIG. 3 is a flow chart illustrating a process for full-duplex real-time cross-module updates of CRM data in a CRM data processing system.

### DETAILED DESCRIPTION OF THE INVENTION

Embodiments of the invention provide for full-duplex real-time cross-module updates of CRM data in a CRM data processing system. In accordance with an embodiment of the invention, different end users access different instances of different CRM modules of a CRM data processing system. Each of the CRM modules provide access to different CRM data objects and some of the CRM data objects may have values that are dependent upon values of others of the CRM data objects. A first CRM module of the CRM data processing system is registered for full-duplex data integration with a second CRM data module of the CRM data processing system. Thereafter, a full-duplex communications channel such as a channel implemented according to the WebSockets protocol, is established between the first and second CRM data modules. Consequently, in response to a data change in a data object of the second CRM module, the data change may be pushed to the first CRM module utilizing the full-duplex communications channel and upon receipt of the pushed data change, data in the first CRM module may be changed based upon the pushed data change so as to be viewable by all of the end users accessing the first CRM module.

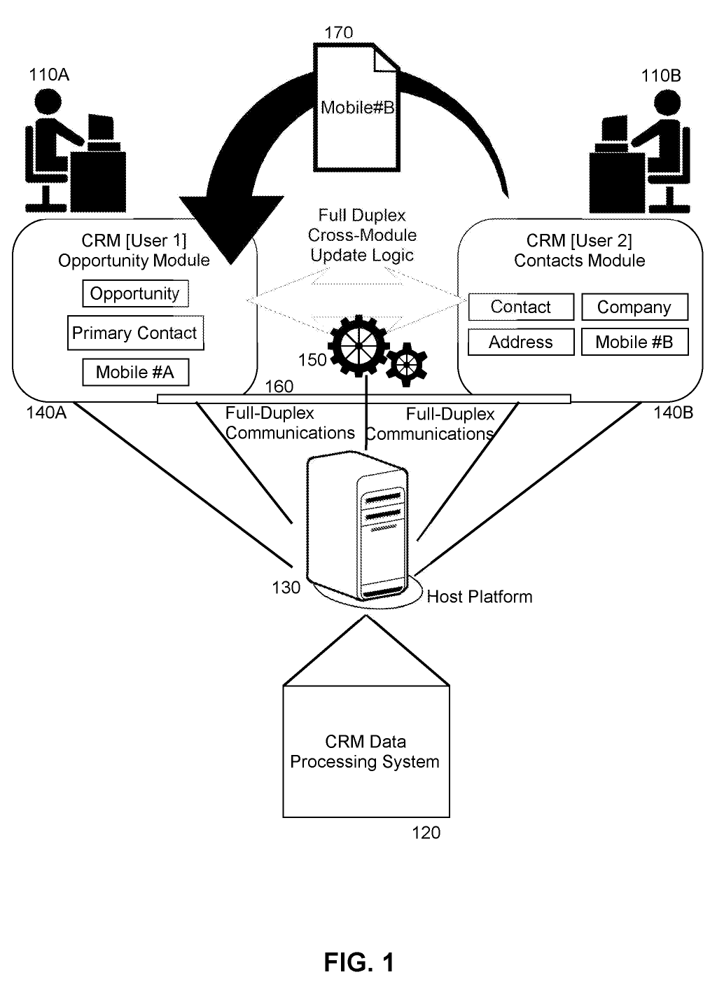

In further illustration, FIG. 1 pictorially shows a process for full-duplex real-time cross-module updates of CRM data in a CRM data processing system. As shown in FIG. 1, a host platform 130 supports the operation of a CRM data processing system 120 that includes multiple different modules, such as an opportunity module in which different business opportunities are defined, tracked and managed, and a contacts module in which different contacts are defined and managed. Different data objects are accessed, created, modified and deleted within each of the modules by different end users and in some instances, a data object of one module is also utilized directly or indirectly in a different module such that the different module is dependent upon the data object of the one module. As illustrated in FIG. 1, then, an instance of an opportunity module 140A is utilized by a first user 110A of the CRM data processing system, and an instance of a contacts module 140B is utilized by a second user 110B of the CRM data processing system, though it is to be recognized that multiple end users may access each of the modules 140A, 140B.

Of note, full-duplex cross-module update logic 150 registers both the opportunity module 140A and the contacts module 140B for full-duplex cross-module real time updating. As such, the full-duplex cross-module update logic 150 establishes a full-duplex communications channel 160 between the opportunity module 140A and the contacts module 140B, for instance in accordance with the hypertext markup language version 5 (HTML5) WebSocket protocol. Subsequently, as a change 170 in a data object of the contacts module 140B is detected, the change 170 is pushed over the full-duplex communications channel 160 to the opportunity module 140A so as to update a data object displayed in the opportunity module 140A. As well, an alert is presented in a user interface for the end user 110A of the opportunity module 140A to alert the end user 110A of the real time change applied to the data object.

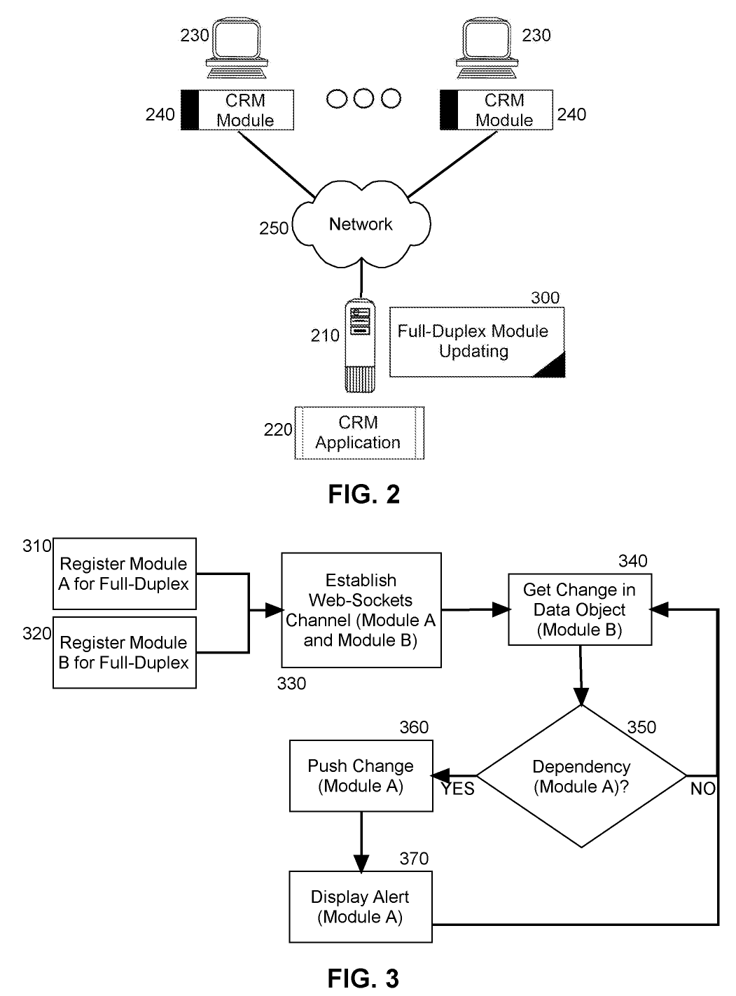

In accordance with an aspect of the present invention, the process described in connection with FIG. 1 is implemented in a CRM data processing system. In yet further illustration, FIG. 2 schematically shows a CRM data processing system configured for full-duplex real-time cross-module updates of CRM data. The system includes a host computing platform 210 that includes one or more computers each with memory and at least one processor (only a single computer shown for the purpose of illustrative simplicity). The host computing platform 210 supports the operation of a CRM application 220 providing access to instances of multiple different modules 240 of the CRM application 220 over computer communications network 250 in the client computing devices 230 of respectively different end users of the CRM application 220.

Importantly, a full-duplex module updating module 300 is coupled to the CRM application 220. The module 300 includes program code that when executes in the memory of the host computing platform 210 is enabled to register different instances of the CRM modules 240 for different end users for full-duplex updating and to establish between each of the registered different instances of the CRM modules 240, a full-duplex communications channel, such as a full-duplex communications channel that implements the WebSocket protocol. Thereafter, the program code is enabled to detect a change in a data object of one of the registered ones of the CRM modules 240 and to push over the full-duplex communications channel, the changed data object to other ones of the registered CRM modules 240 that are dependent upon the changed data object.

In even yet further illustration of the operation of the full-duplex module updating module 300, FIG. 3 is a flow chart illustrating a process for full-duplex real-time cross-module updates of CRM data in a CRM data processing system. Beginning in blocks 310 and 320, first and second modules are registered for full-duplex real-time updating. In block 300, a WebSocket channel is established between each of the modules. Subsequently, a change in a data object of the second module is detected in block 340. In response, in decision block 350 it is determined if a dependency upon the data object that has changed exists in the first module. If not, the change to the data object is ignored. However, if a dependency exists in the first module upon the changed data object, in block 360 the changed data object is pushed to the first module over the WebSocket channel. As well, in block 370, an alert is displayed in a user interface to the first module to indicate the application of a real-time change to a data object in the first module that is dependent upon the changed data object from the second module. Thereafter, the process returns to block 340.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for full-duplex real-time cross-module updates of customer relationship management (CRM) data in a CRM data processing system, the method comprising:
registering a first CRM module of a multi-user CRM data processing system for full-duplex data integration with a second CRM module;
establishing a full-duplex communications channel between the first and second CRM modules; and,
responsive to a data change in the second CRM module, pushing the data change utilizing the full-duplex communications channel to the first CRM module and changing data in the first CRM module based upon the pushed data change.

2. The method of claim 1, wherein the first CRM module of the multi-user CRM data processing system is a different type of CRM module than the second CRM module of the multi-user CRM data processing system.

3. The method of claim 1, wherein the full-duplex communications channel is implemented utilizing the WebSockets protocol.

4. The method of claim 1, wherein a notification is displayed in a user interface of each end user of the CRM data processing system accessing the first CRM module alerting each end user to the pushed data change.

5. The method of claim 1, wherein a multiplicity of end users of the CRM data processing system access the first CRM module in respectively different user interfaces to the first CRM module and are presented with the data change in each of the different user interfaces.

6. A customer relationship management (CRM) data processing system configured for full-duplex real-time cross-module updates of CRM data, the system comprising:
a host computing platform comprising one or more computers, each with memory and at least one processor;
a multi-user CRM data processing system executing in the memory of the host computing platform; and,
a full-duplex CRM data integration module coupled to the multi-user CRM data processing system, the full-duplex CRM data integration module comprising program code that when executing in the memory of the host computing platform is enabled to register a first CRM module of the multi-user CRM data processing system for full-duplex data integration with a second CRM module, to establish a full-duplex communications channel between the first and second CRM modules, and to respond to a data change in the second CRM module by pushing the data change utilizing the full-duplex communications channel to the first CRM module and changing data in the first CRM module based upon the pushed data change.

7. The system of claim 6, wherein the first CRM module of the multi-user CRM data processing system is a different type of CRM module than the second CRM module of the multi-user CRM data processing system.

8. The system of claim 6, wherein the full-duplex communications channel is implemented utilizing the WebSockets protocol.

9. The system of claim 6, wherein a notification is displayed in a user interface of each end user of the CRM data processing system accessing the first CRM module alerting each end user to the pushed data change.

10. The system of claim 6, wherein a multiplicity of end users of the CRM data processing system access the first CRM module in respectively different user interfaces to the first CRM module and are presented with the data change in each of the different user interfaces.

11. A computer program product for full-duplex real-time cross-module updates of customer relationship management (CRM) data in a CRM data processing system, the computer program product comprising a computer readable storage medium having program instructions embodied therewith, the program instructions executable by a device to cause the device to perform a method comprising:
registering a first CRM module of a multi-user CRM data processing system for full-duplex data integration with a second CRM module;
establishing a full-duplex communications channel between the first and second CRM modules; and,
responsive to a data change in the second CRM module, pushing the data change utilizing the full-duplex communications channel to the first CRM module and changing data in the first CRM module based upon the pushed data change.

12. The computer program product of claim 11, wherein the first CRM module of the multi-user CRM data processing system is a different type of CRM module than the second CRM module of the multi-user CRM data processing system.

13. The computer program product of claim 11, wherein the full-duplex communications channel is implemented utilizing the WebSockets protocol.

14. The computer program product of claim 11, wherein a notification is displayed in a user interface of each end user of the CRM data processing system accessing the first CRM module alerting each end user to the pushed data change.

15. The computer program product of claim 11, wherein a multiplicity of end users of the CRM data processing system access the first CRM module in respectively different user interfaces to the first CRM module and are presented with the data change in each of the different user interfaces.
